(19) United States
(12) Patent Application Publication
(10) Pub. No.: US 2006/0159209 A1
(43) Pub. Date: Jul. 20, 2006

(54) MULTI-PIPE SYNCHRONIZER SYSTEM

(76) Inventors: Hung-Yuan Hsu, Hsin-Chu Hsien (TW); Ching-Lin Chung, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,725

(22) Filed: Jan. 18, 2005

(51) Int. Cl. H04L 7/00

(52) U.S. Cl. 375/354

(57) ABSTRACT

A multi-pipe synchronizer system includes at least two synchronizers for receiving a source signal and corresponding source clock, and a destination clock. A switch is coupled to an input of each synchronizer for coupling the source signal to a selected synchronizer. A generator is coupled to an output of each synchronizer. The generator is for merging output of the synchronizers into a destination signal corresponding to the destination clock.

### BACKGROUND OF INVENTION

1. Field of the Invention

The present invention relates to digital electronics, and more specifically, to pulse synchronizers.

2. Description of the Prior Art

Synchronizers are typically used to reduce information loss in systems having more than one clock. Such loss can be in the form of a pulse that is not sampled because its own clock and the sampling clock are too far out of phase. In ideal systems this does not happen since clocks are assumed to have periods that are perfect integer multiples of each other and that are precisely in phase. However in real systems, this problem can occur because clock signals can easily become uncorrelated or skewed by a multitude of reasons including circuit delays, conductor lengths, and interference.

The conventional synchronizer takes as input a source pulse signal and source and destination clock signals that may be out of phase and may have a non-integer relationship of periods. Such a synchronizer compensates for the less-than-ideal relationship of the source and destination clocks and outputs a destination pulse signal that is synchronized with the source pulse signal.

Some state-of-the-art synchronizers are briefly described as follows. U.S. Pat. No. 6,218,874, which is included herein by reference, discloses a one-shot pulse synchronizer. This synchronizer includes an input section of logic, data flip-flops, and a one-shot state machine at the output. U.S. Pat. No. 6,172,538, which is included herein by reference, discloses a universal pulse synchronizer that employs counters and a comparator. In addition, U.S. Pat. No. 6,055,285, which is included herein by reference, discloses a synchronization circuit for transferring pointer values between two asynchronous circuits.

Although there are a wide variety of synchronizers available, ever increasing data transmission rates and intricate communications schemes require a synchronizer that can better handle unexpectedly long clock cycles and other clock or signal irregularities. Such a synchronizer would reduce errors associated with lost pulses.

### SUMMARY OF INVENTION

It is therefore an objective of the invention to provide a multi-pipe synchronizer system and related method of synchronizing signals that solve the above problems.

Briefly summarized, the multi-pipe synchronizer system includes at least two synchronizers for receiving a source signal and corresponding source clock, and a destination clock. A switch is coupled to an input of each synchronizer for coupling the source signal to a selected synchronizer. A generator is coupled to an output of each synchronizer. The generator is for merging output of the synchronizers into a destination signal corresponding to the destination clock.

It is an advantage of the invention that the switch divides the source signal among the synchronizers so that signals sent to each synchronizer are more readily synchronized.

It is an advantage of the invention that pulses of the source signal can be more closely spaced without affecting the expected synchronized destination signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a synchronizer.

FIG. 2 is a schematic diagram of the synchronizer of FIG. 1.

FIGS. 3-8 are waveform diagrams of signals of the synchronizer of FIG. 2.

FIG. 9 is a schematic diagram of a two-pipe synchronizer system according to the invention.

FIG. 10 is a waveform diagram of signals in the two-pipe synchronizer system of FIG. 9.

FIG. 11 is a schematic diagram of an N-pipe synchronizer system according to the invention.

FIG. 12 is a schematic diagram of an application for the N-pipe synchronizer system of FIG. 11.

### DETAILED DESCRIPTION

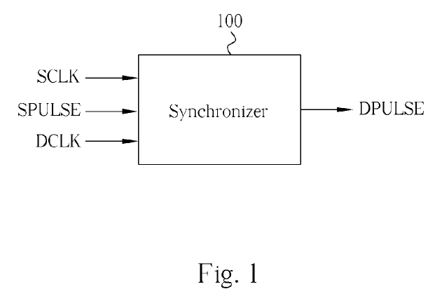

Please refer to FIG. 1, which is a block diagram of a synchronizer 100. The synchronizer 100 has at least three inputs and one output, though in practical implementations there are likely to be additional inputs and outputs such as power, ground, reset, and enable. The inputs of interest are those for a source signal SPULSE (also known as a source strobe signal), a source clock signal SCLK, and a destination clock signal DCLK. The main output is a destination signal DPULSE (also known as a destination strobe signal). Regarding the signals, the terms source and destination are also sometimes known as input and output. The synchronizer 100 can be provided on a single silicon chip or can be provided as discrete digital devices. Generally, the synchronizer 100 would be applied within or between circuits that have signals in at least two clock domains.

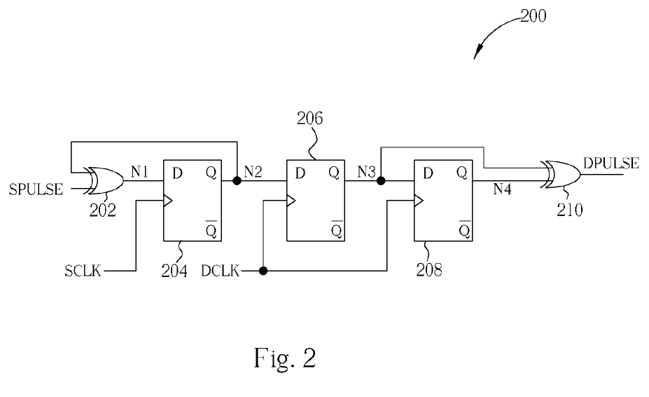

FIG. 2 is a schematic diagram of a synchronizer 200 according to the invention. The synchronizer 200 includes a first exclusive-or logic (i.e. a XOR gate) 202 having an output connected to an input of a first memory unit (i.e. a D-type flip-flop) 204. The first memory 204 unit has an output connected to an input of the first exclusive-or logic 202 and to an input of a second memory unit 206. The second memory unit 206 has an output connected to an input of a third memory unit 208 and to an input of a second exclusive-or logic 210. The third memory unit 208 has an output connected to another input of the second exclusive-or logic 210. The synchronizer 200 can be provided on a single silicon chip or can be provided as discrete digital devices

The exclusive-or logics 202, 210 can each be implemented by any logic circuit or combination of logic gates that results in the truth table of the logical exclusive-or operation. One solution is to use a XOR gate. In other embodiments, the exclusive-or logic can be the well-known combination of two AND gates, two inverters, and an OR gate or can be the equally well-known combination of four NAND gates.

The memory units 204, 206, 208 can each be implemented by a simple memory device, delay circuit, or flip-flop that stores the value (high or low, binary 1 or 0) provided at the input for output during a next clock cycle (i.e. period). One solution is to use a D-type flip-flop. In other embodiments, SR-type flip-flops and/or JK-type flip-flops can be used. Moreover, the memory units 204, 206, 208 need not be identical.

The source signal SPULSE is applied to another input of the first exclusive-or logic 202. The source clock SCLK is applied to the clock input of the first memory unit 204. The destination clock DCLK is applied to the clock inputs of the second and third memory units 206, 208. The destination signal DPULSE is taken from the output of the second exclusive- or logic 210.

The synchronizer 200 can operate according to two frequency modes. In a low-to-high (L2H) mode, the frequency of the source clock SCLK is less than the frequency of the destination clock DCLK. In a high-to-low (H2L) mode, the frequency of the source clock SCLK is greater than or equal to the frequency of the destination clock DCLK. It should be noted that these modes are simply dependant on what clock frequencies are inputted. For the synchronizer 200, a minimum allowable number of cycles of the source clock SCLK between two one-shot pulses can be expressed as

$${n}_{1} \geq \frac{{f}_{SCLK}}{{f}_{DCLK}} = K , \qquad ( 1 )$$

wherein

n₁ is a positive integer, and represents the minimum allowable number of source clock SCLK cycles that can occur between two pulses of the source signal SPULSE;

K is the frequency ratio;

f_{SCLK} is the frequency of the source clock SCLK; and

f_{DCLK} is the frequency of the destination clock DCLK;

assuming that the cycle lengths of the clocks SCLK, DCLK are ideal.

Note that when f_{SCLK} is less than f_{DCLK}, i.e. K<1, the obtained n₁ can be 1, 2, 3, or any other positive integer. This means that the synchronizer 200 is safe for the L2H mode when the source signal SPULSE is coming continuously.

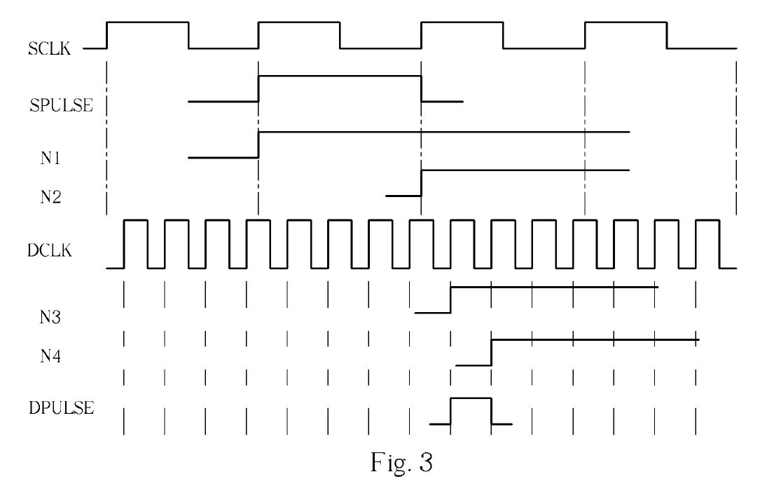

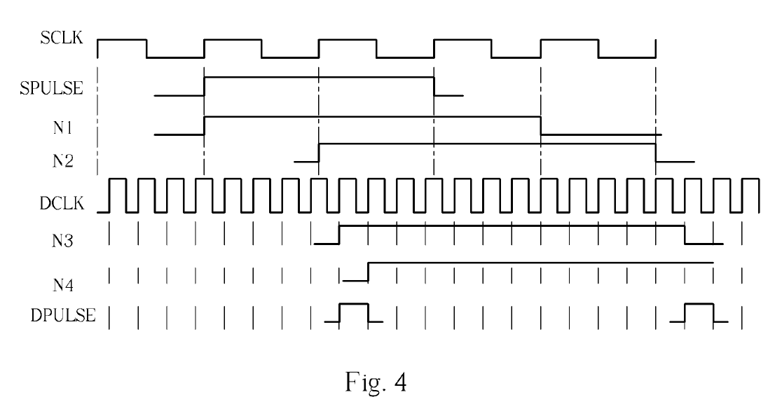

FIGS. 3-8 show waveforms of signals of the synchronizer 200. The signals shown are source clock SCLK, source signal SPULSE, levels at nodes N1 and N2 shown in FIG. 2, destination clock DCLK, levels at nodes N3 and N4 shown in FIG. 2, and destination signal DPULSE. FIG. 3 shows the case of the L2H mode, when the destination clock DCLK frequency is four times the source clock SCLK frequency, i.e. K=1/4. FIG. 4 also shows the case of the L2H mode, however, sequential input pulses of the source signal SPULSE resulting in multiple pulses of the destination signal DPULSE are illustrated.

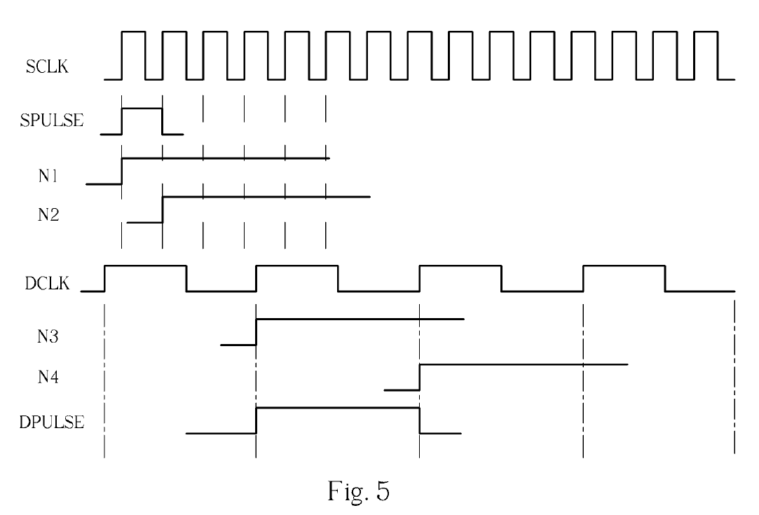

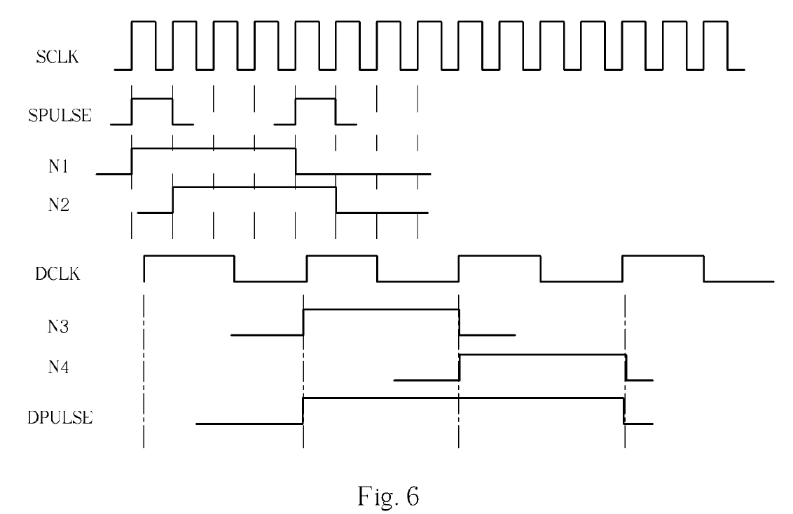

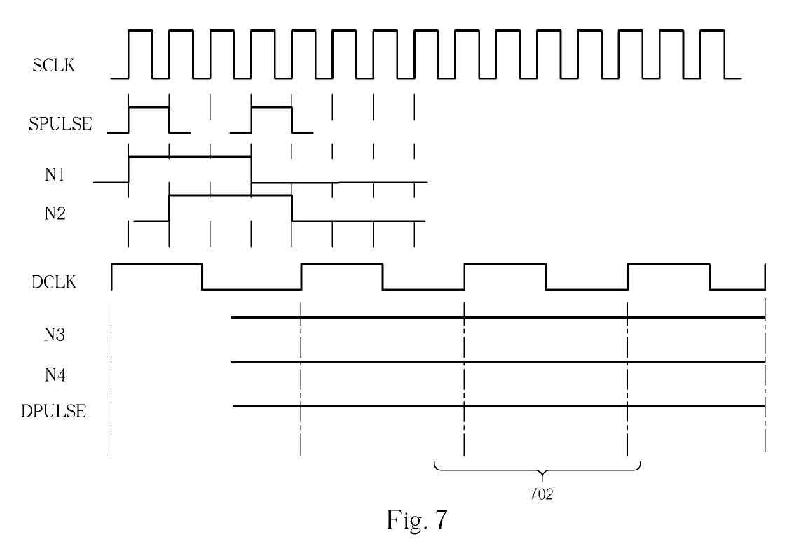

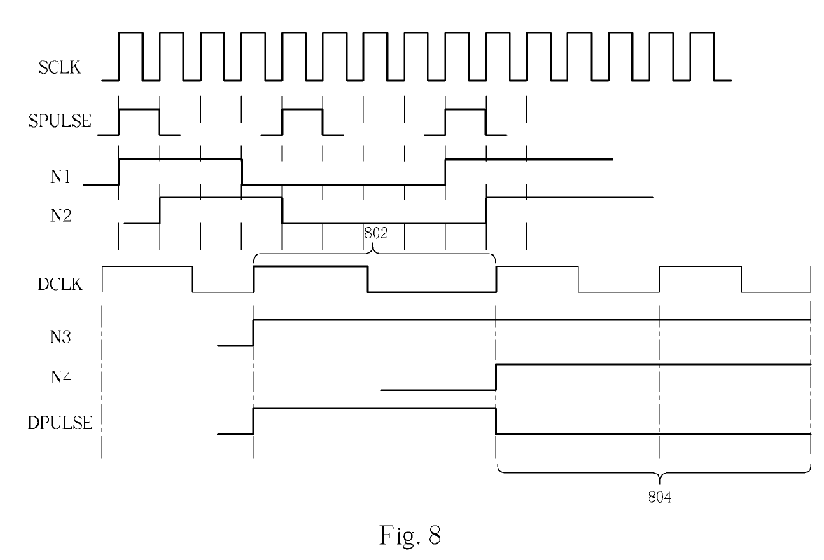

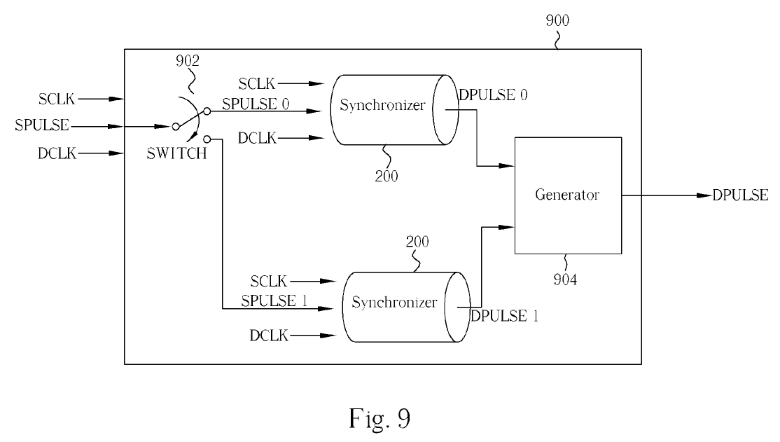

FIG. 5 shows the case of the H2L mode, in which the frequency of the source clock SCLK is four times that of the destination clock DCLK, i.e. K=4. FIG. 5 illustrates the signals associated with a single pulse of the source signal SPULSE. Likewise, FIG. 6 illustrates two input pulses of the source signal SPULSE having leading edges separated by about four periods of the source clock SCLK, resulting in sequential pulses of the destination signal DPULSE. However, as shown in FIG. 7, if a pulse of the source signal SPULSE comes early (within four periods of the source clock SCLK), data can be missing from the destination signal DPULSE. Region 702 in FIG. 7 shows where pulses of the destination signal DPULSE corresponding to the two pulses of the source signal SPULSE are missing because of this problem. Lastly, for the H2L mode, FIG. 8 shows what happens when a pulse 802 of the destination clock DCLK is unexpectedly long, specifically, that the second and third pulses of the source signal SPULSE are lost in the destination signal DPULSE, as indicated by 804.

Naturally, the synchronizer 200 can operate at any suitable frequency ratio, 1/4 and 4 merely being illustrative examples.

Please refer to FIG. 9, which shows a two-pipe synchronizer system 900 according to the invention. The synchronizer system 900 includes a switch 902, a generator 904, and two synchronizers 200 disposed in parallel between the switch 902 and the generator 904. In other embodiments, the two-pipe synchronizer system 900 can employ other kinds of synchronizers, such as the general synchronizer 100, without reducing benefits.

The switch 902 controls which synchronizer 200 receives the source signal SPULSE. The clock signals SCLK, DCLK are provided to both synchronizers 200. In other embodiments, the switch 902 could also selectively provide the clocks SCLK, DCLK to the synchronizers 200. The switch 902 can be a multiplexer or other logic circuit of similar function. When the switch 902 is operated at the correct frequency, the source signal SPULSE is separated into two sub-signals SPULSE0 and SPULSE1, which are provided to the respective synchronizer 200.

The synchronizers 200 each act on their respective source sub-signal SPULSE0, SPULSE1, as described previously with reference to FIGS. 1-8, to produce respective destination sub-signals DPULSE0, DPULSE1. In effect, each synchronizer 200 sees a source sub-signal SPULSE0 or SPULSE1 rather than the true source signal SPULSE.

The generator 904 receives the destination sub-signals DPULSE0, DPULSE1 and merges them into the expected destination signal DPULSE. Preferably, the generator 904 is an up-down counter. In one regard, the two-pipe synchronizer system 900 outputs the same destination signal DPULSE as a single synchronizer 200 would. This is mainly true for when good clock signals SCLK, DCLK are available. However, when a clock SCLK, DCLK is not ideal, the two-pipe synchronizer system 900 still outputs the expected destination signal DPULSE, while a single synchronizer that does not meet the relation of equation (1) would likely output an erroneous signal.

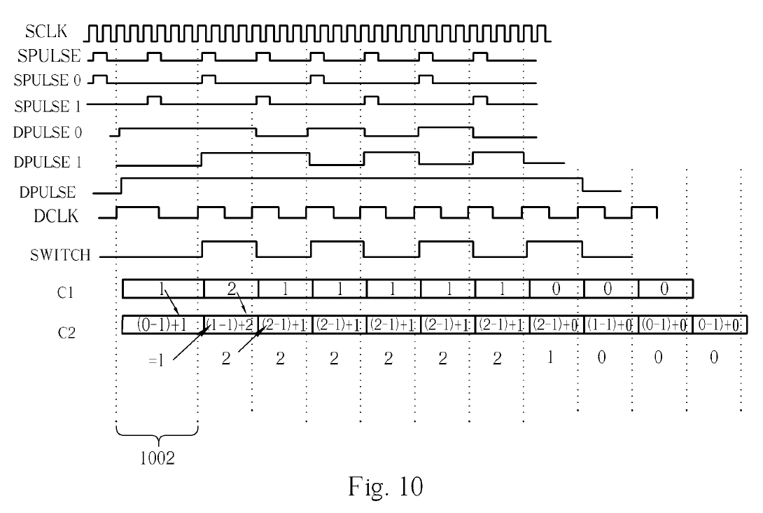

This can be seen in the example of FIG. 10, which is a waveform diagram of signals in the two-pipe synchronizer system 900. When the switch 902 is switched with each period of the destination clock DCLK, an alternating signal SWITCH is produced, and source sub-signals SPULSE0 and SPULSE1 each have alternate pulses of the source signal SPULSE signal. It should be mentioned that, in another example, if the source signal SPULSE lacked a pulse in a certain region, a sub-signal would also lack a pulse there. According to the source sub-signals SPULSE0 and SPULSE1, the destination sub-signals DPULSE0 and DPULSE1 have values as expected, except in the cycle 1002 which is unexpectedly long. Because of this cycle 1002, the first high level of the sub-signal DPULSE0 is too long, and the levels of the second generated pulses of DPULSE0 and DPULSE1 are the same as the levels of the first generated pulses of DPULSE0 and DPULSE1. Despite this unexpectedly long cycle 1002, the two-pipe synchronizer system 900 still generates the expected destination signal DPULSE. This can be understood by referring to generator signals C1 and C2. Assuming the generator 904 is an up-down counter as previously mentioned, the value of C1 is simply a sum of the binary values (high=1, low=0) of the sub-signals DPULSE0 and DPULSE1, and the value C2 is a cumulative sum of previous values C1 reduced by 1 each cycle. Note that for the special case of the first cycle of signal C2, if the value in parenthesis is less than zero it is regarded as zero, i.e. (0-1) becomes 0. Thus, as can be seen in FIG. 10, the generator 902 outputs a high level for the destination signal DPULSE whenever the value C2 is greater than 0. Therefore, the proper destination signal DPULSE can be achieved in spite of the unexpectedly long cycle 1002.

For the two-pipe synchronizer system 900, the minimum allowable number of source clock SCLK cycles that can occur between two pulses of the source signal SPULSE can be expressed as

$${n}_{2} > \frac{1}{2} \frac{{f}_{SCLK}}{{f}_{DCLK}} , where K = \frac{{f}_{SCLK}}{{f}_{DCLK}} , \qquad ( 2 )$$

which is clearly half that of a single synchronizer alone. Note that n₂ is a positive integer. For example, with a frequency ratio, K, of 4, n₂>2, which means the minimum space between adjacent one-shot pulses can be reduced to three cycles of the source clock SCLK. Therefore, the two-pipe synchronizer system 900 according to the invention has improved tolerance to signal irregularity. In fact, with a frequency ratio, K, of 4, the source clock SCLK can actually be tolerated to be up to eight times than that of the destination clock DCLK.

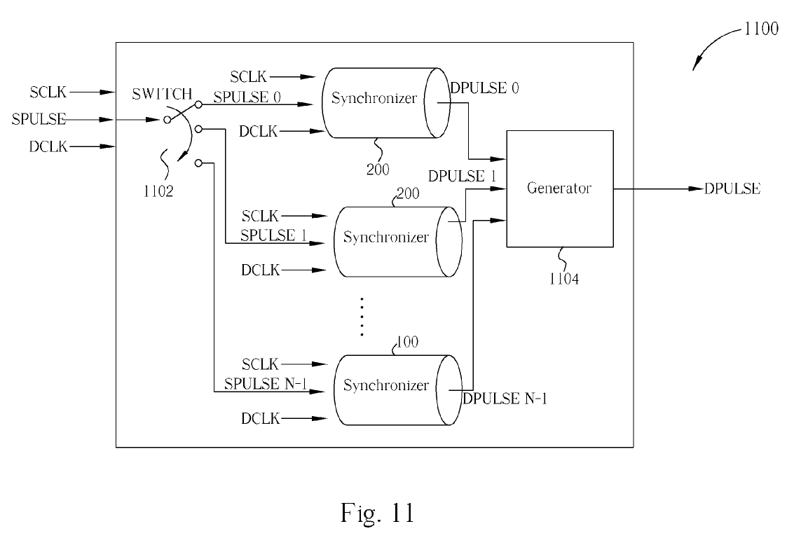

Please refer to FIG. 11, which shows a multi-pipe or N-pipe synchronizer system 1100 according to the invention. The synchronizer system 1100 includes a switch 1102, a generator 1104, and a plurality of synchronizers 200 disposed in parallel between the switch 1102 and the generator 1104. In other embodiments, the N-pipe synchronizer system 1100 can employ other kinds of synchronizers such as the general synchronizer 100. The synchronizers 200 each act on a respective source sub-signal SPULSE0 to SPULSEN-1, and accordingly provide a respective destination sub-signal DPULSE0 to DPULSEN-1. The switch 1102 can be a multiplexer or other logic circuit of similar function, and the generator 1104 is preferably an up-down counter. The N-pipe synchronizer system 1100 is similar in structure and operation to the two-pipe synchronizer system 900 of FIG. 9 except that the number of synchronizers 200 is increased.

For the N-pipe synchronizer system 1100, the minimum allowable number of source clock SCLK cycles that can occur between two pulses of the source signal SPULSE can be expressed as

$${n}_{N} > \frac{1}{N} \frac{{f}_{SCLK}}{{f}_{DCLK}} , where K = \frac{{f}_{SCLK}}{{f}_{DCLK}} , \qquad ( 3 )$$

which clearly offers advantages in direct proportion to the number, N, of synchronizers used. Note that n_{N} is a positive integer.

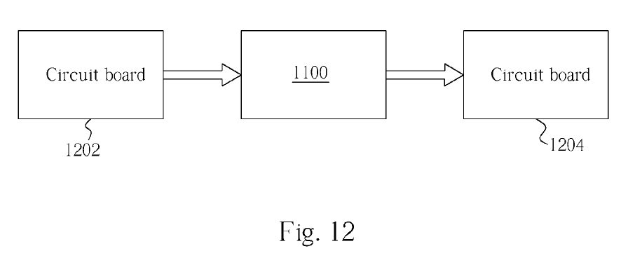

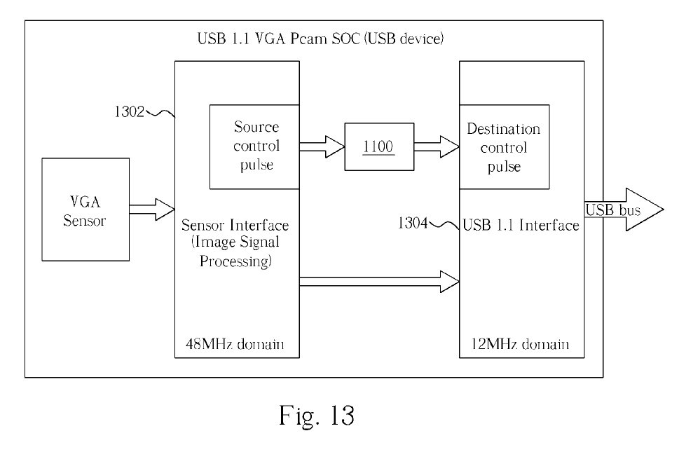

Please refer to FIG. 12 and FIG. 13, which illustrate an application for the N-pipe synchronizer system 1100 of FIG. 11 or the two-pipe synchronizer system 900 of FIG. 9. In FIG. 12, two circuit boards 1202, 1204 are connected by the N-pipe synchronizer system 1100. In FIG. 13, the application could be a universal serial bus (USB) 1.1 PC Camera that can be a system-on-chip (SOC) device having a connection between a sensor interface 1302 and a USB 1.1 interface 1304. In this case the source clock SCLK would be about 48 MHz at the sensor interface 1302 allowing the camera to provide 30 frames per second (FPS), the destination clock DCLK would be about 12 MHz at the USB 1.1 interface 1304, and so the frequency ratio, K, would be 4 as in previous examples. The USB 1.1 PC Camera application is specifically suitable for the two-pipe synchronizer system 900.

In contrast to the prior art, the invention provides improved handling of unexpectedly long clock cycles and other clock or signal irregularities. This is achieved by the switch dividing the source signal among several synchronizers so that signals sent to each synchronizer are more readily synchronized, and by the generator merging the outputs of the synchronizers into the expected destination signal. Moreover, pulses of the source signal can be more closely spaced without adversely affecting the destination signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-pipe synchronizer system comprising:
at least two synchronizers for receiving a source signal and corresponding source clock, and a destination clock;
a switch coupled to an input of each synchronizer for coupling the source signal to a selected synchronizer; and
a generator coupled to an output of each synchronizer, the generator for merging output of the synchronizers into a destination signal corresponding to the destination clock.

2. The multi-pipe synchronizer system of claim 1, wherein a synchronizer comprises:
a first exclusive-or logic having a first input coupled a selectable output of the switch;
a first memory unit having a data input coupled to an output of the first exclusive-or logic, a clock input coupled to a source clock, and an output coupled a second input of the first exclusive-or logic;
a second memory unit having a data input coupled to the output of the first memory unit and a clock input coupled to a destination clock;
a third memory unit having a data input coupled to the output of the second memory unit and a clock input coupled to a destination clock; and
a second exclusive-or logic having a first input coupled to an output of the third memory unit, a second input coupled to the output of the second memory unit, and an output coupled to the generator.

3. The multi-pipe synchronizer system of claim 2, wherein the generator comprises an up-down counter.

4. The multi-pipe synchronizer system of claim 2, wherein the first, second, and third memory unit are D-type flip-flops.

5. The multi-pipe synchronizer system of claim 4, wherein the first and second exclusive-or logics are XOR gates.

6. The multi-pipe synchronizer system of claim 2, wherein the output of the first memory unit is directly connected to the data input of the second memory unit, and the output of the second memory unit is directly connected to the data input of the third memory unit.

7. The multi-pipe synchronizer system of claim 2, wherein the switch comprises a multiplexer.

8. The multi-pipe synchronizer system of claim 1, wherein the generator comprises an up-down counter.

9. The multi-pipe synchronizer system of claim 8, wherein a synchronizer comprises:
a first exclusive-or logic having a first input coupled a selectable output of the switch;
a first memory unit having a data input coupled to an output of the first exclusive-or logic, a clock input coupled to a source clock, and an output coupled a second input of the first exclusive-or logic;
a second memory unit having a data input coupled to the output of the first memory unit and a clock input coupled to a destination clock;
a third memory unit having a data input coupled to the output of the second memory unit and a clock input coupled to a destination clock; and
a second exclusive-or logic having a first input coupled to an output of the third memory unit, a second input coupled to the output of the second memory unit, and an output coupled to the generator.

10. The multi-pipe synchronizer system of claim 9, wherein the output of the first memory unit is directly connected to the data input of the second memory unit, and the output of the second memory unit is directly connected to the data input of the third memory unit.

11. The multi-pipe synchronizer system of claim 9, wherein the first, second, and third memory unit are D-type flip-flops.

12. The multi-pipe synchronizer system of claim 11, wherein the first and second exclusive-or logics are XOR gates.

13. The multi-pipe synchronizer system of claim 8, wherein the switch comprises a multiplexer.

14. A method for synchronizing signals, comprising:
receiving a source signal;
separating the source signal into at least two source sub-signals by cycling through the source sub-signals according to a period of a destination clock, providing the cycled source sub-signal with a corresponding level of the source signal and providing the remaining source sub-signals with a predetermined level;
for each source sub-signal, according to a source clock producing a destination sub-signal that is synchronized with the destination clock; and
merging the synchronized destination sub-signals into a destination signal.

15. The method of claim 14, wherein merging comprises:
for a cycle of the destination clock, summing binary values of corresponding levels of the destination sub-signals, reducing by one a cumulative value of a previous cycle of the destination clock, and adding the sum to the reduced cumulative value to obtain a cumulative value of a current cycle of the destination clock; and
when the current cumulative value is greater than zero, providing the destination signal with a first level, otherwise providing the destination signal with a second level.

16. The method of claim 15, wherein a high signal level corresponds to a binary one and a low signal level corresponds to a binary zero, and the first level of the destination signal is high and the second level of the destination signal is low.

17. A method for synchronizing signals, comprising:
receiving a source signal;
a step for separating the source signal into at least two source sub-signals;
for each source sub-signal, according to a source clock producing a destination sub-signal that is synchronized with the destination clock; and
a step for merging the synchronized destination sub-signals into a destination signal.
